(19) United States
(12) Patent Application Publication
(10) Pub. No.: US 2025/0197033 A1
(43) Pub. Date: Jun. 19, 2025

(54) A Satellite Designed to be Stacked and Launched in Groups

(71) Applicant: AscendArc, Inc., Portland, OR (US)

(72) Inventor: Christopher J. MCLAIN, Portland, OR (US)

(73) Assignee: AscendArc, Inc., Portland, OR (US)

(21) Appl. No.: 18/856,300

(22) PCT Filed: Apr. 12, 2023
(86) PCT No.: PCT/US2023/065675

§ 371 Date: Oct. 11, 2024

Related U.S. Application Data
(60) Provisional application No. 63/330,271, filed on Apr. 12, 2022.

(51) Int. Cl. B64G 1/64; B64G 1/00; B64G 1/10; B64G 1/44

(52) U.S. Cl. CPC B64G 1/643; B64G 1/1007; B64G 1/1085; B64G 1/005; B64G 1/443

(57) ABSTRACT

Stackable satellites with a large diameter antenna that are configured to stack within each other like fully overlapping shallow bowls and to fit tightly within the area in a pay load fairing. The bowl-shaped satellites allow the satellites to nest within each other so that many satellites can be stacked within the height limits of the launch vehicle pay load fairing. A cradle is used to hold the stack, and tensions cables keeps the satellites in compression during launch. The satellite is an antenna with the bus integrated into the antenna structure. The antenna occupies the entire diameter/footprint of the satellite and thus can be matched up with the cross section of the fairing. This allows the largest possible antenna size to be launched without a complex deployment mechanism.

This application claims the benefit of pat. app. No. 63/330,271, filed 12 Apr. 2022, and incorporates it herein by reference.

### BACKGROUND OF THE INVENTION

### Field of the Invention

The present invention relates to satellite and payload designs. In particular, the invention relates to stackable satellite with a large aperture antenna configured to be launched in groups.

### Discussion of Related Art

Some satellite designs are built around a boxy structure that contains the bus and payload components with the antennas be mounted on the top face, which is also called the earth deck, or folded up against the sides of the satellite body. This design limits the size of the antennas to 40% to 60% of the diameter of the payload fairing and requires a complex mechanism to deploy the reflectors.

Some designs for launching multiple satellites use a dispenser where satellites are mounted on a central structure. These are sometimes called launch trees because the satellites hang off a central column like branches of a tree off a tree trunk. These launch trees take up mass and volume in the payload fairing which reduce the mass and volume available to the satellites being launch However, launch adapters take up considerable volume, limiting the size of the satellites and requiring considerable mass, which reduces the useful payload of the launch vehicle.

### SUMMARY OF THE INVENTION

This satellite design offers superior economics to other satellite and communications payload designs by maximizing the size of the satellite antennas and number of satellites that can be launched at once.

This satellite design in some embodiments features a large antenna that can be stacked and launched in groups. In some embodiments, all of the components of the payload and satellite bus are integrated into a single large antenna that can be up to the same diameter as the launch vehicle payload fairing. Only a handful of components such as the antenna sub-reflector and solar arrays are deployed, minimizing the complexity and cost of the satellite. Once stowed for launch, many similar copies of the satellite can be stacked like a stack of plates or bowls within the height limits of the launch vehicle fairing.

Multiple satellites each form a dish shape. The satellites stack together in a substantially overlapped manner so that the stack fits tightly within a payload fairing. The footprint of the stack is matched to the footprint of the payload fairing, to within a few percent. Thus, the stack of satellites efficiently occupies the payload fairing. Generally the satellites are concave and stack within each other. Each satellite has a concave side and a convex side, each satellite other than end satellites stacks with its convex side resting within the concave side of an adjacent satellite. A cradle may be provided to hold the stack, with the cradle curved to match the curve of the bottom satellite. The cradle has a top shaped and sized to correspond to either a concave side of an end satellite or a convex side of an end satellite, depending on how the stack is oriented.

The stack of satellites has substantially the height of a single satellite, plus the thickness of a single satellite times the number of satellites within the stack. Thus, little space is wasted. For example, the thickness of a satellite might be about half of the height of a satellite or less. The satellites might have a circular or roughly circular footprint, for example a polygon with six, eight, or more sides.

In some cases each satellite is based on an antenna sized to fill a footprint of the satellite and has a thin, flat bus integrated within and under the antenna. This allows the thickness of the satellite at any point thinner than the height of the satellite and allows them to be stacked efficiently like shallow bowls. The busses might be thin, generally disk shapes, being circular or roughly circular (e.g. octagonal).

The stacked configuration likely includes at least 10 satellites. The stack is held together in a vertically compressed stack, for example with tension cables. The satellites can be launched in a group, by releasing the cables.

In general each satellite forms an antenna which has a feed array, a fixed reflector, and a deployable sub-reflector. The sub-reflector is located at the center of the fixed reflector and wherein the fixed reflector illuminates the deployable sub-reflector. The satellites may be configured to receive signals are phase combined and transmit signals are phased aligned so that a group of beams can behave as a single beam.

### BRIEF DESCRIPTION OF THE DRAWINGS

FIG. 1 is a side isometric view of a stack of satellites.

FIG. 2 is a side isometric cutaway view of a stack of satellite within a launch vehicle payload fairing.

FIG. 3A is an isometric view of a stackable satellite in a stowed configuration.

FIG. 3B is an isometric view of the satellite of FIG. 3A in a deployed configuration. FIG. 3C is a back isometric view of the satellite of FIG. 3A in a deployed configuration. FIG. 3D is an isometric view of the antenna portion of the satellite of FIG. 3A.

FIG. 4 is a cross-sectional cutaway view of a stackable satellite showing the satellite body and bus.

FIG. 5 is a cross-sectional cutaway view of three stacked satellite.

FIG. 6 is a cross-sectional cutaway view of three stacked satellite on a cradle.

FIG. 7 is an isometric view of a satellite disassembled for shipping.

FIG. 8 is a side cutaway view of multiple stacked satellites stacked and a cradle and held in compression with tension cables.

FIG. 9A is an isometric view of a stackable satellite in a stowed configuration.

FIG. 9B is an isometric view of the satellite of FIG. 9A in a deployed configuration. FIG. 9C is a cross-sectional cutaway view of the satellite of FIG. 9A.

FIG. 10 is a block diagram showing a communications payload design.

FIG. 11 is a schematic view an example of deployed stackable satellite in use to cover an area.

FIG. 12 is a schematic of how deployed stackable satellite provide coverage of a larger area.

FIGS. 13A, 13B and 13C are schematic diagrams showing connectivity between transmit and receive beams. FIG. 13A shows a loop back configuration, FIG. 13B shows a point-to-point configuration, and FIG. 13C shows a point-to-multi-point configuration.

FIG. 14 is a block diagram showing a payload passive feed array.

FIG. 15 is a block diagram showing a payload active section.

FIG. 16 is a block diagram showing payload feed switching.

FIGS. 17A, 17B, and 17C are block diagrams showing feed switch use cases.

FIG. 17A shows a loopback direction change, FIG. 17B shows receive and transmit routed to a transport layer, and FIG. 17C shows replicating and combining signals.

FIG. 18 is a schematic top view showing transport layer connectivity between feeds and beams for deployed stackable satellite.

FIG. 19 is a schematic diagram showing a transfer switch.

FIGS. 20A, 20B, and 20C show the transport layer of FIG. 19 in use. FIG. 20A shows loopback, FIG. 20B shows gateway to user, and FIG. 20C shows point-to-point.

### DETAILED DESCRIPTION OF THE INVENTION

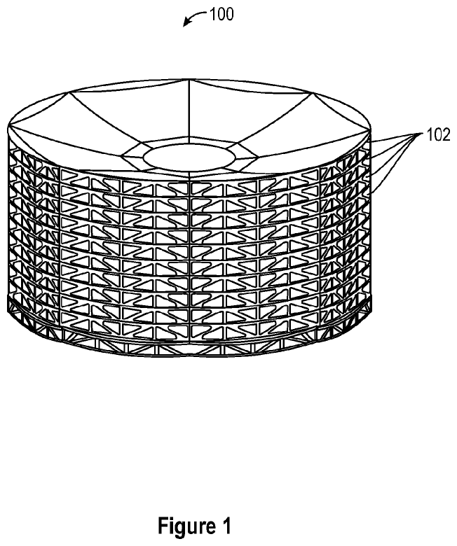

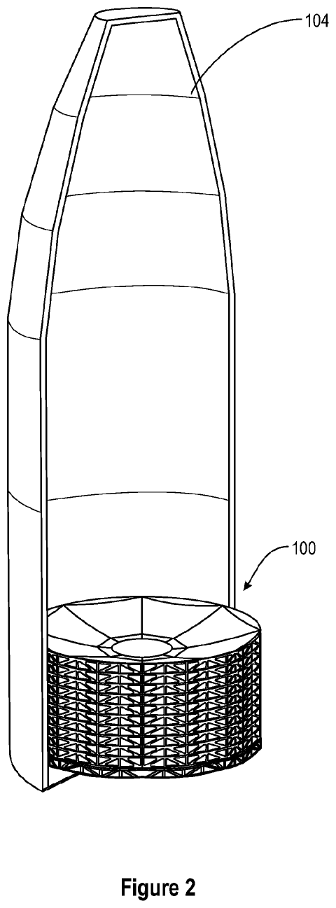

FIG. 1 is a side isometric view of a stack 100 of satellites 102. This satellite 102 in some embodiments features a large diameter antenna and can be stacked and launched in groups. FIG. 2 is a side isometric cutaway view of a stack 100 of satellites 102 within a launch vehicle payload fairing 104. In some embodiments, all of the components of the payload and satellite bus are integrated into a single large satellite 102 that can be up to the same diameter as the launch vehicle payload fairing as shown in FIG. 2. Satellites 102 are stacked in a substantially overlapped manner. The footprint of stack 100 is the same as the footprint of an individual satellite 102, to within a few percent.

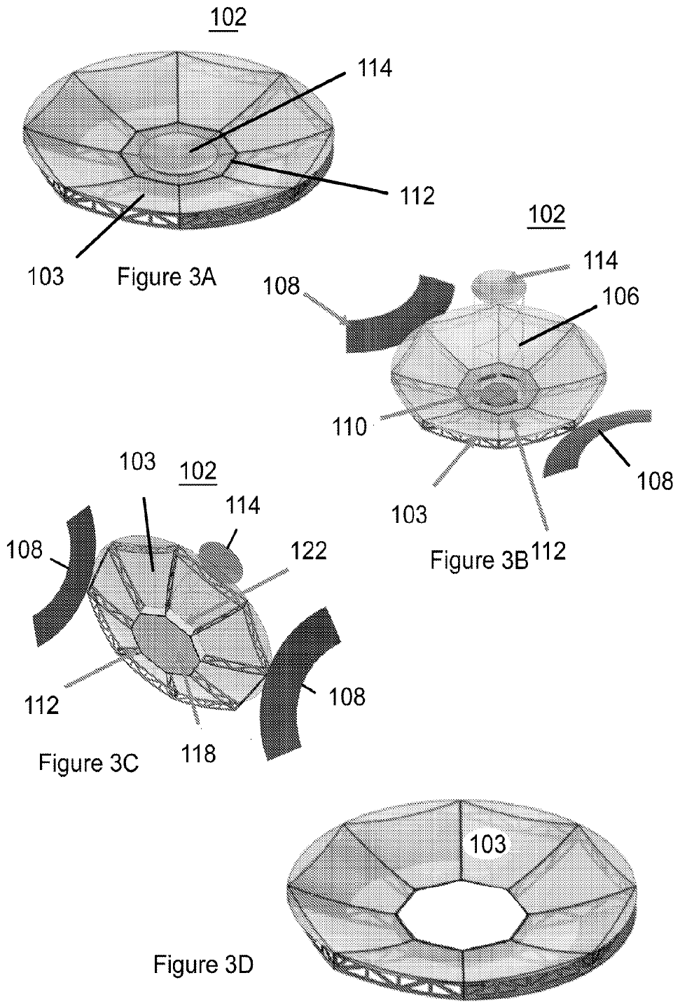

FIG. 3A is an isometric view of a stackable satellite 102 in a stowed configuration, with solar panels 108 folded within the footprint of satellite 102 and sub-reflector 114 retracted against the upper surface of satellite 102. The majority of the diameter of the satellite 102 is occupied by the antenna 103. FIG. 3B is an isometric view of a stackable satellite 102 in a deployed configuration. Solar arrays 108 are folded out from the edges of the antenna 103 and sub-reflector 114 is extended upward on structure 106. A payload feed array 110 that illuminates the sub-reflector is located at the center of the main reflector. FIG. 3C shows satellite 102 from the back. FIG. 3D shows the antenna 103 portion of satellite 102.

Usually satellites have a boxy bus with antennas deployed off the sides. Satellite 102 is an antenna 103 with the bus integrated into the antenna structure. Antenna 103 occupies the entire diameter of the satellite 102 and thus can be matched up with the cross section of the launch vehicle payload fairing 104. This allows the largest possible antenna size to be launched without a complex deployment mechanism.

In some embodiments, the antenna 103 is a Cassegrain reflector. In other embodiments the satellite antenna may take the form of a Gregorian reflector, center feed reflector, reflect array or Fresnel reflector. The antenna can be made from a variety of materials including metals such as aluminum, carbon fiber, fiberglass, metalized plastic or mesh materials that are reflective at the operating frequency of the antenna.

In some embodiments, the antenna is fed from a payload feed array 110 located at the center of the main reflector that illuminates a deployable sub-reflector 114. In a Cassegrain configuration this sub-reflector 114 is a hyperbola. The payload feed array 110 may consist of a one or many feeds, that may be horns, patches, helixes, Yagi antennas, dielectric rods, or other antenna types that can direct a signal at the sub-reflector.

In some embodiments, the feed array 110 is located at the prime focus of the reflector and sub reflector system so that each feed or cluster of feeds produces a beam. In other embodiments, the feed array may be located in front of or behind the focal plane in an array feed reflector configuration where many feeds are phase combined to form a beam. In center feed reflector embodiment, the feed array may be deployed in front of the main reflector and pointed back towards the main reflector antenna.

Note the terms related to orientation like top, bottom, front, back, sides, etc. are used for convenience in discussing the drawings. Elements may be in other orientations within the spirit of the invention. For example, stack 100 may be upside down compared to these drawings.

Only a handful of components such as the antenna sub-reflector 114 and solar arrays 108 are deployed, minimizing the complexity and cost of the satellite. Once stowed for launch, many similar copies of the satellite can be stacked like a stack of plates or bowls within the height limits of the launch vehicle fairing, as shown in FIG. 2.

In some embodiments, this satellite 102 design maximizes the diameter and radio frequency gain of the antenna 103 within the constraints of the launch vehicle payload fairing 104 diameter without the complexity of deployable antenna. The satellite may be sized such that its diameter is substantially as large as the diameter of the fairing, so the almost no cross-sectional area is wasted. For example, the cross-sectional area of the satellite might be 80% of the cross-sectional area of the fairing, or 90%, or 95%, or even up to 99% if both cross-sections are the same shape, such as circular. For example, the cross-sectional area of a hexagon is about 83% of a circle circumscribing it, the area of an octagon is about 90% of a circle circumscribing it and the area of a circle may approach 99%.

The height of a stack 100 of satellites 102 is substantially equal to the height of a single satellite plus the thickness of a single satellite times the number of satellites in the stack 100. With careful design the height of stack 100 can be within 95% or even 99% of this number. For the purposes of this discussion, the height of the satellite is the distance between the lowest and uppermost component on the satellite in the vertical direction and the thickness of the satellite is the maximum distance between upper and lower surface of the satellite at any point on the satellite. In some embodiments, the thickness of the satellite may be substantially less than the height of the satellite leading to a substantial reduction in the total height of the stack.

The large diameter and high gain of the antenna allows high radio frequency (RF) performance with low transmit power. Low transmit power in turn allows the use of low-cost, solid-state payload components and a low-cost, low-power satellite bus. Stacking satellites allows many satellites to be launched in a group, which reduces cost of launching each satellite. Stacking also greatly reduces the satellite dispenser and associated cost and mass. This method both maximizes the throughput of each satellite while minimizing the cost of the satellite and the cost of the launch, resulting in a very low cost per unit of performance.

In various embodiments, this satellite design can be used in Low Earth Orbit (LEO), Medium Earth Orbit (MEO, Geostationary Earth Orbit (GEO), Highly Elliptical Earth Orbit (HEO), in orbits around the sun or in orbits around other celestial bodies such as the moon or mars.

This satellite design can be used for communication missions, radiometers, radar, radio astronomy, and other missions that would benefit from high gain and directivity of a large antenna diameter. Communications payloads may take the form of array feed reflectors with analog or digital beam forming, single-feed or multi-feed-per-beam systems, bent-pipe or regenerative payloads, and may use solid state or traveling wave tube amplifiers.

Embodiments of the communications payload may operate in any radio frequency band including, UHF, L-band, S-band, C-band, X-band, Ku-band, Ka-band, V-band, Q-band and W-band. The payload may operate with linear or circular radio frequency signals.

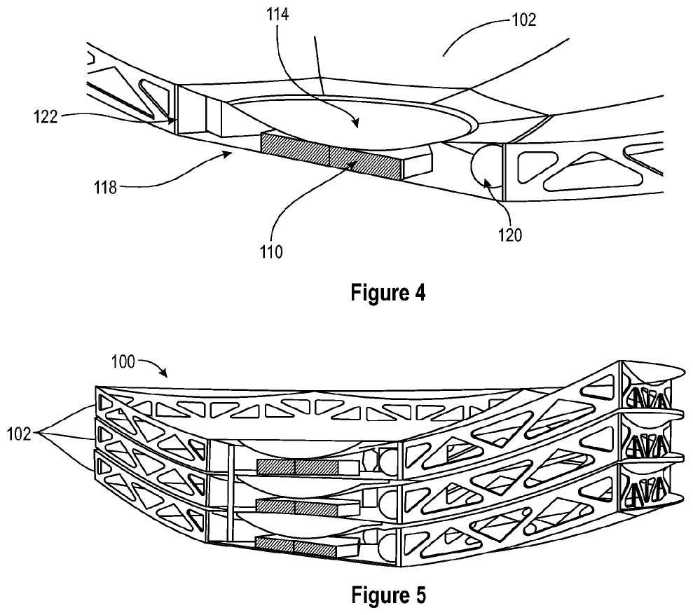

FIG. 4 is a cross-sectional cutaway view of a stackable satellite 102 showing its satellite body and bus. In this example, payload/bus deck 118 is perpendicular to the satellite Body/Bus walls 122 that carry structural loads down through the stack during launch. This deck 118 provides a mounting location for Bus components 120 and payload feed array 110. Bus components 120 may include batteries, power supply, processor, telemetry, star trackers, reaction wheels, propellant storage, star trackers and other elements necessary for the function of the satellite (not shown). Payload feed array 110 may include the feed array for the antenna, processors and switching. Payload/Bus deck 118 might be made with aluminum Isogrid construction, which is stiff and highly conductive of heat and allows the Payload/Bus deck 118 to act as the primary thermal radiator for the satellite. In other embodiments, Payload/Bus deck 118 may be constructed of composite or aluminum honeycomb panels or composite materials such as carbon fiber.

In one embodiment, the height of the baseline satellite 102 is 62 cm and the thickness is 33 cm. Thus, a stack of 20 satellites could have a height within a few percent of 722 cm. It is helpful to have the thickness of a satellite 102 be substantially less than the height of a satellite 102, in order to take advantage of a reduced height of the entire stack 100. In this example the thickness of a satellite 102 is approximately one-half of the height of the satellite 102.

Satellite 102 comprises an antenna 103 sized to fill a footprint of the satellite and a thin, flat bus fitted within and under the antenna. In this example, the bus is a thin octagonal shape. In other embodiments, the bus may be a thin disk shape.

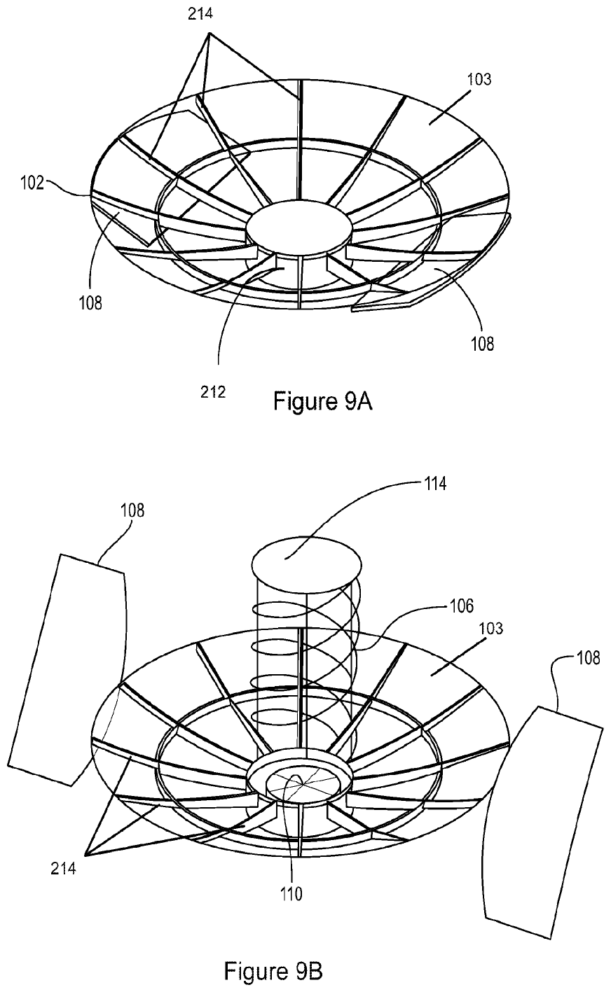

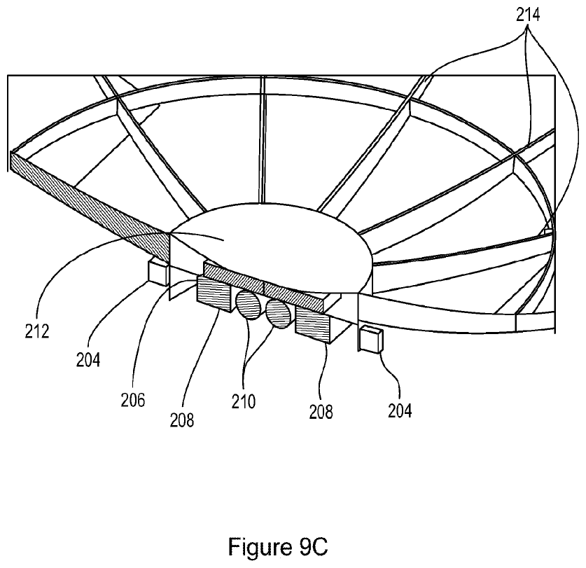

The walls of the satellite body may form a regular polygon like the octagon shown in FIG. 7, or a circular, disk or cylindrical shape as shown in FIG. 9C. In other embodiments the walls of the satellite body may have different numbers of sides or be circular, or near circular.

In some embodiments, these walls are made from honeycomb core composite panels. In other embodiments, these walls may be made of metal, such as aluminum, composites such as carbon or other structural materials typically used for satellites.

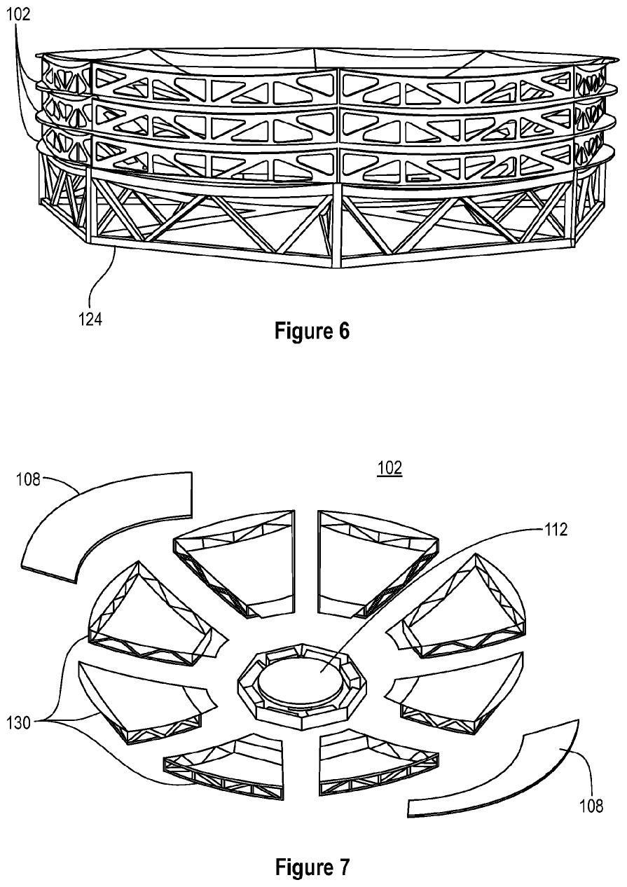

FIG. 5 is a cross-sectional cutaway view of three stacked satellites 102 of FIG. 4. FIG. 6 shows the satellite stack 100 of FIG. 4 disposed within a cradle 124. In this example satellites 102 are shaped like shallow bowls with the concave side up and the convex side down. The bottom most satellite 102 in the stack rests in a cradle 124, which has a concave side on its top sized and shaped to fit the convex bottom of the bottom-most satellite 102. Of course the satellites could be oriented with the convex side up and the concave side down, meaning that the cradle would have convex surface to correspond with the concave surface of the bottom-most satellite.

Cradle 124 acts as the interface between the launch vehicle and the stack 100 of satellites 102, and transfers loads from stack 100 to the launch vehicle. Cradle 124 can be much smaller and lighter than a typical launch adapter/dispenser. Different embodiments of cradle 124 can be made of metal tubes or sheets, such as aluminum, composite materials or honeycomb panels.

FIG. 7 is an isometric view of satellite 102 disassembled into components for shipping. In this example, the antenna reflector is divided into wedge shaped antenna segments 130 that can be removed from the satellite body 112 for shipping. This allows a satellite 102 that might be too big for conventional ground shipping to broken into parts that can be shipped in standard size trucks and containers.

Each segment 130 of antenna 103 consists of a section of reflector surface and supporting structure. In this embodiment the supporting structure consists of honeycomb composite panels with wire bracing. In other embodiments, the structure can consist of metal, such as aluminum, or composite, such as carbon fiber.

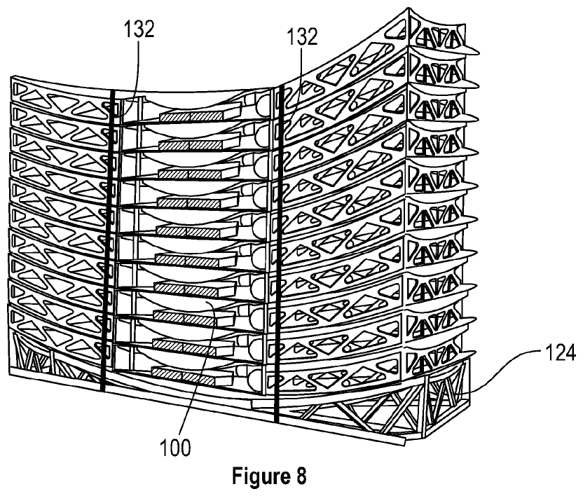

FIG. 8 is a side cutaway view of a stack 100 of stacked satellites 102 stacked on cradle 124 and held in compression with tension cables 132. Alternatively, tension rods or clamps could be used. Satellites 102 experience their highest loads during launch due to the acceleration of the launch vehicle, lateral buffeting, vibration loading. Stack 100 are preferably strong to carry the static loads and stiff to resist bending and vibrational loads. Acceleration loads are passed down through the stack 100 to the base cradle 124 where the stack 100 mounts to the launch vehicle. Much of the mass of the satellite is concentrated in the satellite Body/Bus section 112 and the acceleration loads are carried downward through the stack by the walls of satellite body to the launch vehicle interface.

Similarly, the loads on the antenna structure are passed downward at points where the antenna structures contact each other, such as at the edges of the antenna. Each satellite supports the satellites above it, creating a strong, stiff structure with minimum mass. At the base of the stack is a cradle 124 that translates the forces from the stack into the launch vehicle interface.

In FIG. 8, stack 100 of satellites 102 is held in compression for launch by a set of several tension cables 132 that extend from the top satellite 102 in the stack to the bottom satellite 102 or cradle 124, as shown in here. When payload fairing 104 is jettisoned, stack 100 reaches orbit and satellites 102 are released by cutting the tension cables 132. This can be done at one or more places along the cable length, which provides a level of redundancy if one cable cutter fails.

Alternative embodiments may constrain the stack 100 of satellites 102 using clamps or tension rods or other methods.

FIG. 9A is an isometric view of a stackable satellite 202 in a stowed configuration. FIG. 9B is an isometric view of satellite 202 in a deployed configuration. FIG. 9C is a cross-sectional cutaway view of satellite 202 showing the satellite body/bus 212, including payload feed array 206, and bus components 204, 208, 210, for example thrusters, propellant tanks, etc. Elements similar to satellite 102 in satellite 202 have the same reference numbers.

In this embodiment antenna 203 has a structure based on ribs 214 that are cantilevered off satellite Body/Bus section 212. The acceleration loads acting on satellite 202 are channeled back to satellite Body/Bus section 212. In this embodiment, satellite Body/Bus 212 is an aluminum cylinder based on a EELV Secondary Payload Adapter (ESPA) adapter, which is a commonly available standard. This cylinder is divided by the Payload/Bus deck 216 with the payload components 206 mounted on top of deck 216 and bus components 204, 208, 210 mounted on the bottom. As with other embodiments of the satellite design, the deployable elements like solar arrays, sub reflectors and radiator panels are stowed and then the satellite can be stacked for launch.

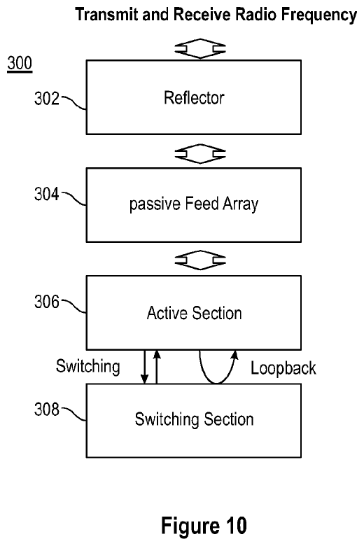

FIG. 10 is a block diagram showing an example communications payload design 300 that takes advantage of high gain and directivity to deliver high data rates and throughputs at a very low cost. The high gain and directivity of the satellite design allows for a greatly simplified payload where communications functions are carried out by low-power, low-cost solid-state components. The payload consists of a passive feed array 304 located at the prime focus of the satellite antenna reflector 302, an active section 306, and a switch section 308. This arrangement allows for high capacities and a high degree of flexibility without the complexity, power, and cost of digital channelizers and beam formers.

The active section 306 receives signals from users, translates the signals between the transmit and receive frequencies, and amplifies the signals for transmission in the form of a bent pipe transponder.

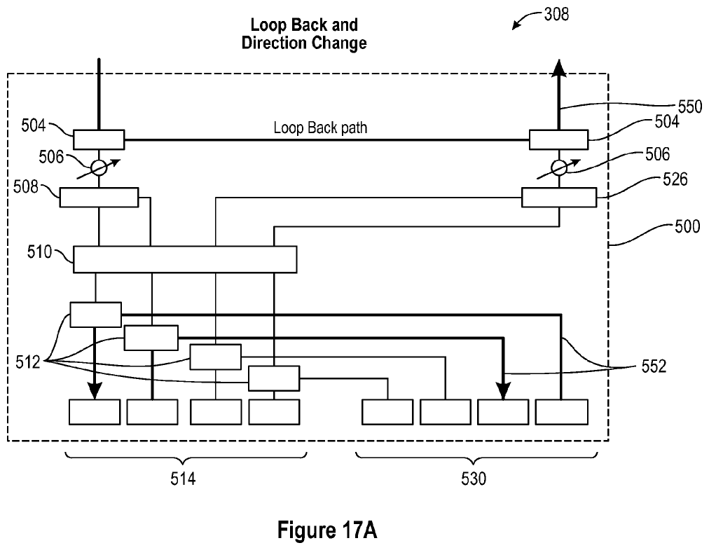

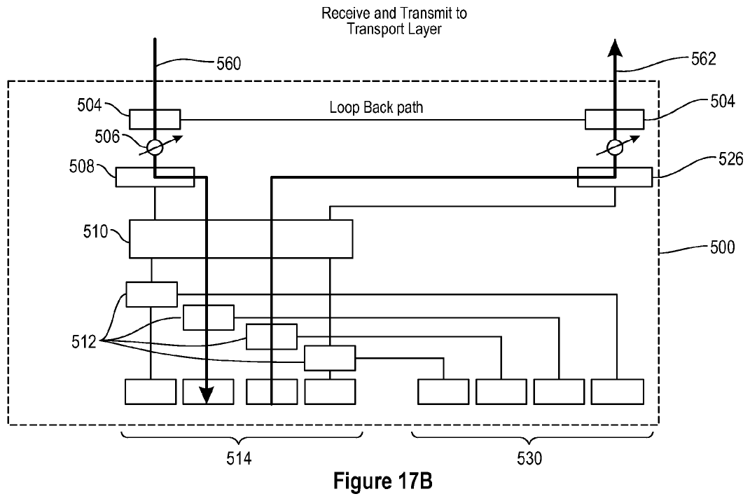

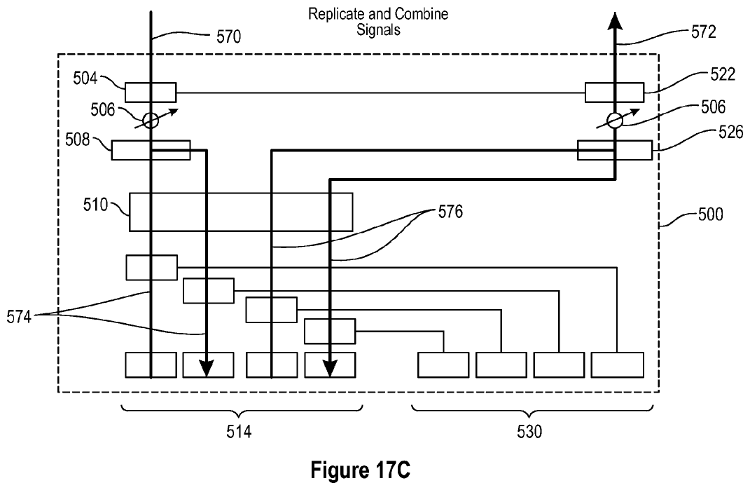

The switching section 308 allows different connectivity between receive and transmit beams (see FIGS. 17A-C).

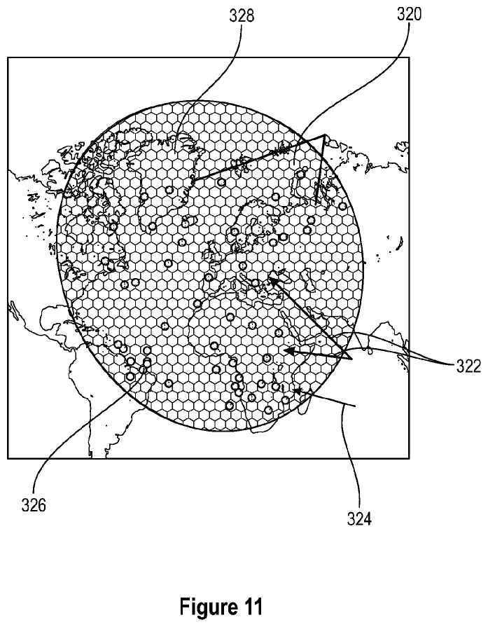

FIG. 11 is a schematic top view an example of deployed stackable antennas in use to cover an area 328. The feed array in this payload design produces many transmit and receive beams that are projected onto the surface of the earth. Some embodiments of this design produce 1000 beams in a 3.6 deg field of view from geostationary orbit. In the conventional Ka-band, each of these beams can support 500 MHz up uplink and downlink spectrum in a single polarization and 700 Mbps of throughput. Up to 360 beams may be active at a time, depending on the power and thermal limitation on the satellite allowing a total throughput of 250 Gbps per satellite. These beams can be activated to serve different user sets like mobile ships and aircraft 322, user concentration points 320 like airports and the urban halo areas, cruise ports 324 and oil and gas drilling platforms 326. Other embodiments may serve other user sets, have larger or smaller numbers of beams, and have larger or smaller fields of view.

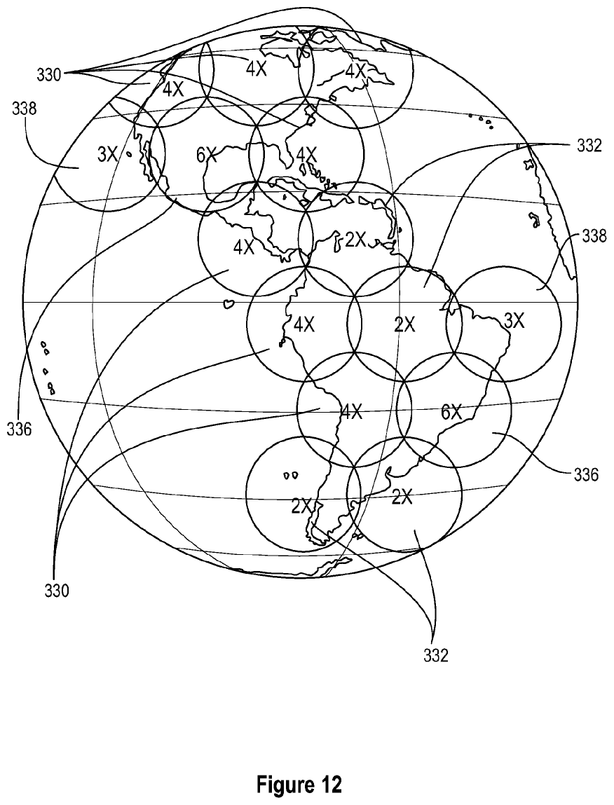

FIG. 12 is a schematic side view of how deployed stackable antennas 102 provide coverage of a larger area. This embodiment of satellite and payload design can be used in groups at a single Geostationary orbital slot to take advantage of the ability of the satellite design to be launched in stacks. Multiple satellites 102 having the communications payload design of FIG. 4 or FIG. 7 can be deployed to a single orbital slot to serve all of North and South America. Each of the 15 circles represents the field of view of a satellite. Up to six satellites of this embodiment can be pointed at each field of view with each satellite activating roughly ⅓ of the beams in each of two polarizations. The number of satellites assigned to each field of view in this example can be varied from 1 (not shown), 2 (332), 3 (338), 4 (330), 5 (not shown) to 6 (336) depending on the amount of demand in the beam so that capacity can be scaled as demand grows over time. Ultimately, up to 90 satellites (15 fields of view×6 satellites) could be assigned to this single orbital slot providing up to 22,500 Gbps of capacity, which is an unprecedented amount of capacity. Other orbital slots could accommodate even more capacity.

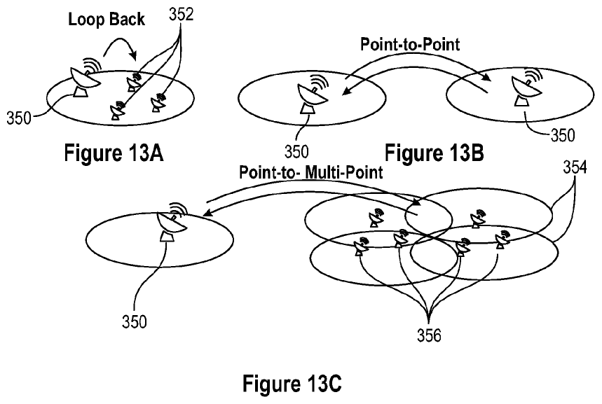

FIGS. 13A, 13B and 13C are schematic diagrams showing connectivity between transmit and receive beams. FIG. 13A shows a loop back configuration, FIG. 13B shows a point-to-point configuration, and FIG. 13C shows a point-to-multi-point configuration.

Loop-Back connectivity shown in FIG. 13A translates the receive frequency in one beam to the transmit frequency in the same beam. This allows range extension around a hub from a main satellite 350 to secondary satellites 352, which can be used to extend coverage in the urban halo around cities where the population is moderately dense but fiber and cable have not reached.

Point-to-point connectivity in FIG. 13B connects two satellites 350, the receive in one beam to the transmit in another beam. This allows gateway terminals to be connected to remote sites and mobile terminals. Finally, point-to-multi-point connectivity in FIG. 13C connects the receive in one beam from antenna 350 to the transmit in multiple beams at antennas 356 and the receive in multiple beams to the transmit in one beam. This allows groups of beams to be served by a single gateway. In one embodiment of a point-to-multi-point connectivity, the receive signals are phase combined and the transmit signals are phased aligned so that a group of beams can behave as a single wide or shaped beam. Such beams can be used for broadcast or to form mesh networks over an extended area.

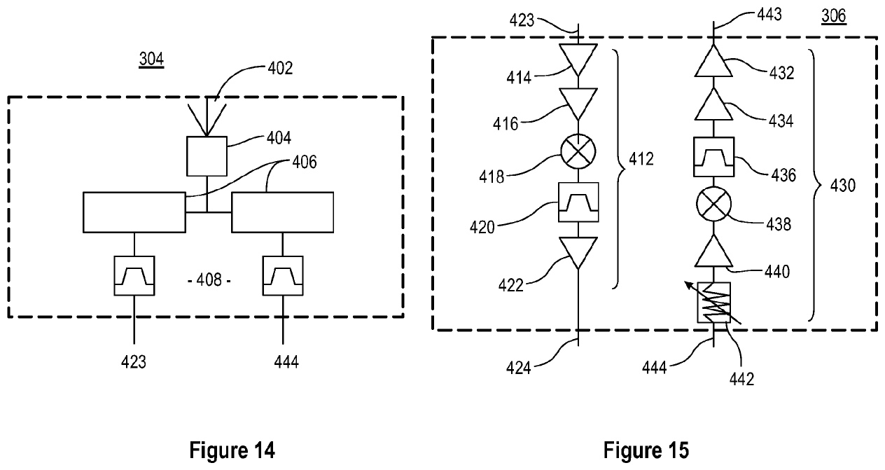

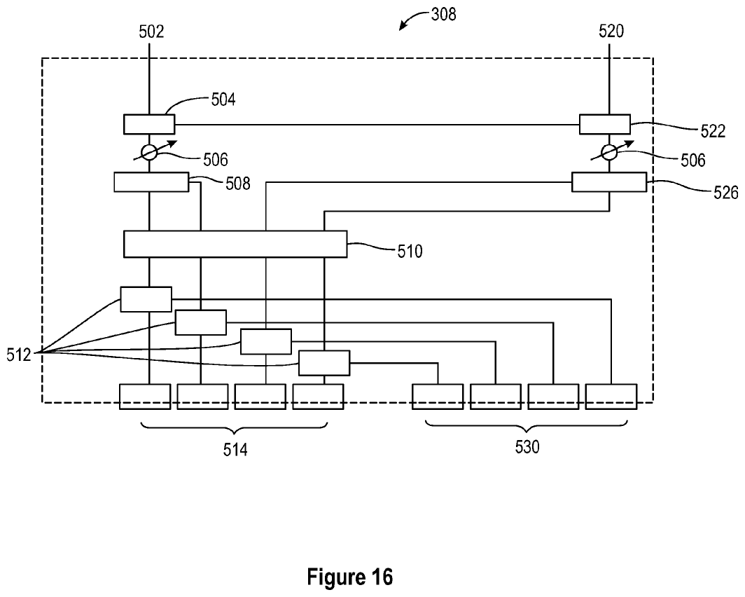

FIG. 14 is a block diagram showing a payload passive feed array 304 from FIG. 10. FIG. 15 shows the payload active section 306 from FIG. 10. FIG. 16 shows payload feed switching 308 from FIG. 10.

FIG. 14 shows passive feed array 304 (see FIG. 10). It includes an antenna 402 connected to ortho mode transducer 404, multi-feed per beam networks 406, and channel filters 408. It provides receive chain input 423 and receives transmit chain output 444. As an example, passive feed array 304 consists of multiple horn antennas 402 with septum polarizers 404, a multi-feed per beam network 406, and cavity filters 408 that provide band pass filtering. These elements can be 3D printed from aluminum or metalized plastic so that many feeds can be manufactured at once at low cost.

In some embodiments, the feeds may be in the form of patch elements, helixes, Yagi antennas, dielectric rods, or other antenna types. In these embodiments, passive feed array 304 may be implemented in printed circuit boards or assembled from discrete parts.

FIG. 15 shows active section 306. Active section 306 consists of a receive chain 412 and a transmit chain 430. The receive chain 412 receives input 423 and includes Low Noise Amplifier (LNA) 414 and frequency conversion components such as driver 416, mixer 418 and filtering 420. The Receive section 412 may also include driver amplification 422 to provide output 424.

The transmit chain 430 includes a high-powered amplifier 432 and may include variable attenuation 442, frequency conversion components such as driver 440, mixer 438, filtering 436, and driver amplification 434. The frequency conversion components may translate signals directly from the receive frequency 443 to the transmit frequency 444 or, in one embodiment, translate it to an intermediate frequency such as L-band, S-band or C-band.

In some embodiments, all the components of the active section are solid state and can be implemented for a large number of feeds on a single Printed Circuit Board (PCB) that interfaces directly with the 3D printed passive feed array through PCB to waveguide transitions. Implementing the active section on a PCB allows it to be manufactured in volume and at low cost with standard PCB processes. Interfacing the PCB directly to the 3D printing also allows the 3D printing to be used as a heat sink for the active section.

In some embodiments, active section 306 may be implemented on multiple PCB and the interface between active section 306 and passive feed array 304 may be made by coax cable connections.

FIG. 16 shows payload feed switching section 308 from FIG. 10. The switching section 308 allows analog signals to be routed from receive chains to transmit chains within the payload. This switching section consists of feed switching and a transport layer. The feed switching is a set of switches associated with each feed or group of feeds that produce a beam. This makes each feed a node on transport layer network that connects all of feeds together. Since each feed or group of feeds produce a beam, the switch section allows signals to be routed between beams. The transport layer routes signals between feeds at different locations within the feed array.

In some embodiments, the switching is done at an intermediate frequency that is different from the transmit and receive frequencies, such as L-band, S-band or C-band. This reduces the loss within the switching section and allows the use of low-cost solid-state components. In other embodiments, the switching may be done at the transmit or receive frequencies.

Feed switch section 308 connects to the transmit and receive chains of active section 306 for each feed and to the transport layer. The components in the feed switch may include Single Pole Dual Throw (SPDT) switches 504, phase shifters 506, splitters and combiners 508, 526, matrix switches 510, and transfer switches 512, 514, 530 that allow a signal arriving on any port 502 to be directed to any other port. In this embodiment, feed switch section 308 is implemented with solid state components on a PCB. This may be the same PCB as active section 306 or a separate PCB.

FIGS. 17A, 17B, and 17C are block diagrams showing feed switch use cases 500. FIG. 17A shows a loopback direction change, FIG. 17B shows receive and transmit routed to a transport layer, and FIG. 17C shows replicating and combining signals.

Loop-Back connectivity shown in FIG. 17A translates the receive signal in one beam to the transmit signal in the same beam. This allows range extension around a hub, which can be used to extend coverage in the urban halo around cities where the population is moderately dense but fiber and cable have not reached. FIG. 17A shows how signals can be routed from receive chain 412 to transmit chain 430 (see FIG. 15) in the same feed (loop-back) 550 and how signals arriving from one direction on the transport layer to be redirected to other direction in the transport layer 610 (see FIGS. 19-21C).

Point-to-point connectivity in FIG. 17B connects the receive in one beam 560 to the transmit in another beam 562. This allows gateway terminals to be connected to remote sites and mobile terminals. FIG. 17B shows how signals from receive chain 412 can be routed to transport layer 610 (see FIG. 19) and from transport layer 610 to transmit chain 430, allowing point-to-point links.

Finally, point-to-multi-point connectivity in FIG. 17C connects the receive 570 in one beam to the transmit 574 in multiple beams and the receive 576 in multiple beams to the transmit 562 in one beam. This allows groups of beams to be served by a single gateway. In one embodiment of a point-to-multi-point connectivity, the receive signals are phase combined and the transmit signals are phased aligned so that a group of beams can behave as a single wide or shaped beam. Such beams can be used for broadcast or to form mesh networks over an extended area.

FIG. 17C shows how signals can be replicated and combined, allowing point-to-multi-point links and wide beams. Phase shifters 506, 524 are used in this case to phase combine receive signals 570 and phase align transmit signals 562 to and from a single wide beam. Other embodiments may include functions to sub-channelize signals or support different numbers of transport layer connections.

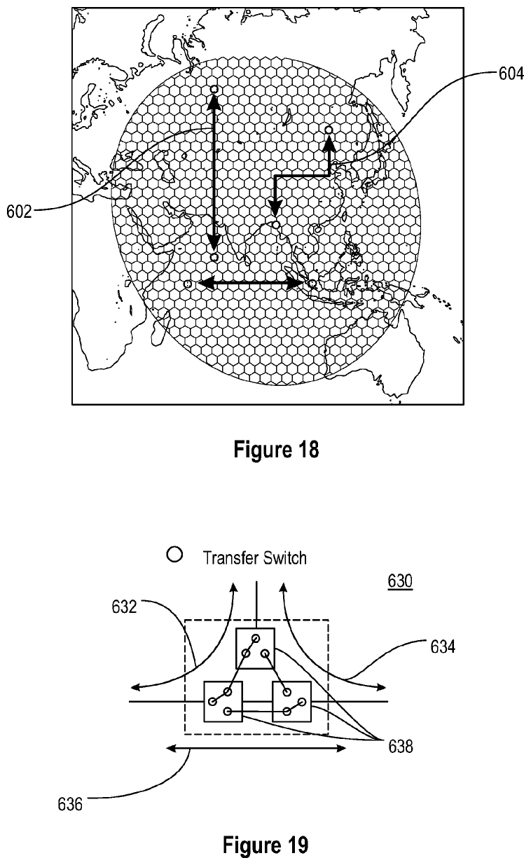

FIG. 18 is a schematic top view showing transport layer connectivity between feeds and beams for deployed stackable antennas. The transport layer 610 allows feeds and their associated beams in different points of the feed array to be connected. In one embodiment, the feed array is arranged in columns (North/South) and rows (East/West) as shown in FIGS. 16-17C. Signals can be switched to travel up and down columns and rows. Signals can be “turned” from rows to columns and vice versa using the change direction function of the feed switches as illustrated in FIG. 17A.

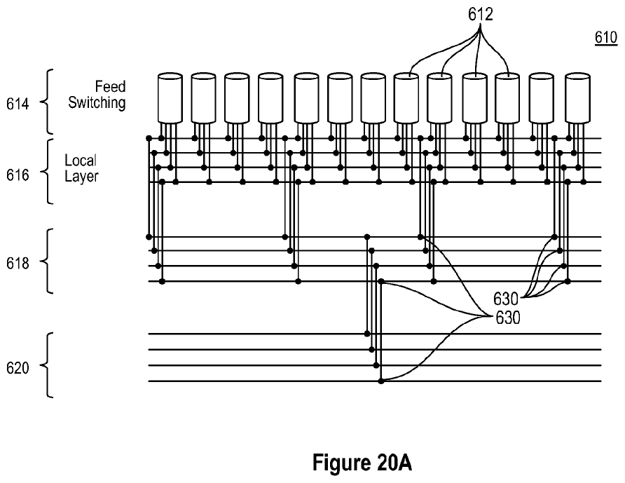

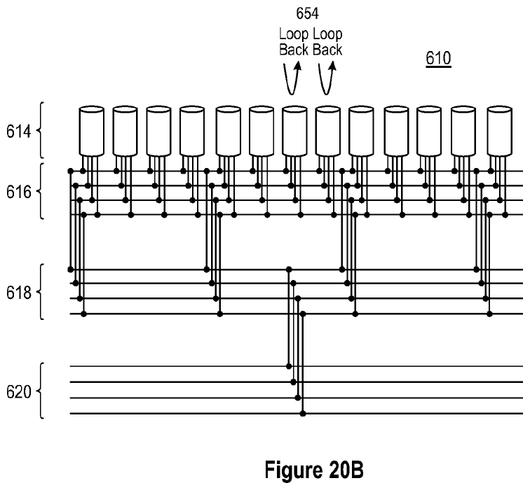

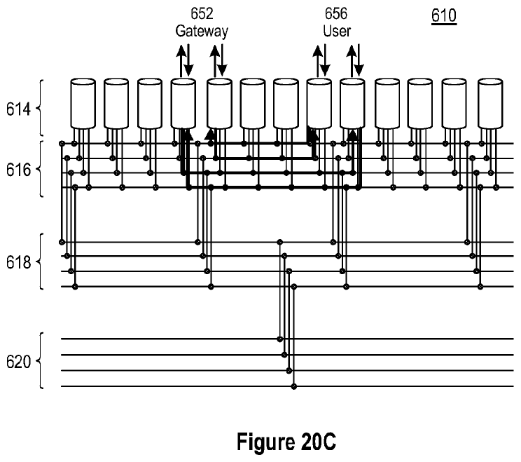

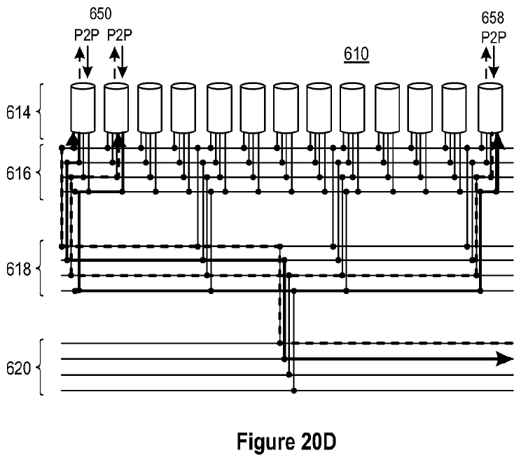

FIG. 19 illustrates transfer switches 630, which allow a signal arriving on any of three or more ports to be directed to any other port via 632, 634, 636. In the embodiment shown in FIGS. 20A-D, a transfer switch 630 is implemented as three SPDT switches 638. In other embodiments, a transfer switch can be implemented in a single application specific integrated circuit (ASIC).

FIG. 20A is a schematic black diagram showing a transport layer 610 along a row. Transport layer 610 allows signals to be switched along rows and columns of feeds using analog switches. In this example, transport layer 610 is organized in one or more layers 616, 618, 620 with multiple signal lines in each layer. Signals are switched into signal lines, out of signal lines, and between layers using transfer switches 630.

The first layer or local layer 616 of the transport layer 610 functions like a local road allowing signals to be passed between near adjacent feeds. Higher layers 618, 620 allow signals to skip over local congestion and travel over longer distance without passing through as many switches. A second layer 618 is like an arterial road that connects different neighborhoods, and a third layer 620 is like a freeway that allows long distance travel. Different embodiments may be in different numbers of layers, different numbers of lines in each layer, and different connectivity between layers.

FIGS. 20B, 20C, and 20D show the transport layer of FIG. 20A in use to connect different feeds/beams along a single row using the multiple layers. FIG. 20B shows loopback 654.

FIG. 20C shows gateway to user links 652, 656. Signals from other Gateway 652 to user 656 links can by-pass these loop-back beams 654 on the local layer.

FIG. 20D shows point-to-point 650, 658. Signals supporting point-to-point (P2P) links 650, 658 can be routed to the 2nd and 3rd layers depending on how far they need to travel, skipping over local congestion and many intermediate switches 630.

While the exemplary preferred embodiments of the present invention are described herein with particularity, those skilled in the art will appreciate various changes, additions, and applications other than those specifically mentioned, which are within the spirit of this invention. For example,

What is claimed is:

1. Apparatus comprising:
multiple satellites, the satellites each forming a dish shape having a diameter and a cross-sectional area;
each satellite including an antenna configured to occupy the majority of the satellite cross-sectional area;
the satellites configured to stack together in a substantially overlapped manner to form a stacked configuration;
the satellites configured to be disposed within a payload fairing in the stacked configuration, the payload fairing having a footprint;

2. The apparatus of claim 1 wherein the antennas occupy at least 80% of the cross-sectional area of the satellites.

3. The apparatus of claim 2 wherein the stacked configuration is configured to have a footprint matching the payload fairing footprint, such that the stacked configuration footprint occupies the majority of the payload fairing footprint.

4. The apparatus of claim 3 wherein the satellites occupy at least 80% of a cross-sectional area of the payload fairing.

5. The apparatus of claim 1 wherein the stacked configuration is configured to have a footprint matching the payload fairing footprint, such that the stacked configuration footprint occupies the majority of the payload fairing footprint.

6. The apparatus of claim 4 wherein the satellites occupy at least 80% of a cross-sectional area of the payload fairing.

7. The apparatus of claim 1 wherein the stacked configuration includes at least 10 satellites.

8. The apparatus of claim 1 wherein the dish shape of each satellite has a concave side and a convex side, and wherein each satellite other than end satellites is configured to stack with its convex side resting within the concave side of an adjacent satellite in the stacked configuration.

9. The apparatus of claim 8 further comprising a cradle configured to hold the stacked configuration, the cradle having a surface shaped and sized to correspond to either a concave side of an end satellite or a convex side of an end satellite.

10. The apparatus of claim 8 wherein a stack of satellites having a number of satellites has substantially a height of a single satellite, plus a thickness of a single satellite times the number of satellites within the stack.

11. The apparatus of claim 8 wherein the satellites have a roughly circular footprint.

12. The apparatus of claim 11 wherein the satellites have a regular polygon footprint where the polygon has at least 6 sides.

13. The apparatus of claim 8 wherein the thickness of a satellite is about half of the height of a satellite or less.

14. The apparatus of claim 1 wherein a stack of satellites having a number of satellites has substantially a height of a single satellite, plus a thickness of a single satellite times the number of satellites within the stack.

15. The apparatus of claim 1, wherein the satellites have a roughly circular footprint.

16. The apparatus of claim 15 wherein the satellites have a regular polygon footprint where the polygon has at least 6 sides.

17. The apparatus of claim 1 wherein each satellite further comprises a thin, flat bus integrated within the cross-section of the antenna and under the antenna.

18. The apparatus of claim 1 further comprising a hold down element configured to hold the stacked configuration in a vertically compressed stack.

19. The apparatus of claim 1 wherein the hold down element comprises tension cables. and under the antenna.

20. The apparatus of claim 1

[symbol]

21. (canceled)
